(19) United States
(12) Patent Application Publication
(10) Pub. No.: US 2023/0334397 A1
(43) Pub. Date: Oct. 19, 2023

(54) TASK ALLOCATION SUPPORT APPARATUS, TASK ALLOCATION SUPPORT METHOD, AND PROGRAM

(71) Applicant: Nippon Telegraph and Telephone Corporation, Tokyo (JP)

(72) Inventors: Satoshi TAKATSU, Musashino-shi, Tokyo (JP); Tomoko SHIBATA, Musashino-shi, Tokyo (JP); Hiroshi Yoshida, Musashino-shi, Tokyo (JP)

(21) Appl. No.: 18/025,565

(22) PCT Filed: Sep. 14, 2020
(86) PCT No.: PCT/JP2020/034700

§ 371 Date: Mar. 9, 2023

(51) Int. Cl. G06Q 10/0631

(52) U.S. Cl. CPC G06Q 10/06316; G06Q 10/063112

(57) ABSTRACT

In one embodiment, a work assignment support device is configured to: classify past assignment table data indicating assignment of work to workers into data at normal time and data at time of saturation by comparison between a workable amount determined from a number of the workers and an actual amount of work; set a threshold to each of a plurality of items on the basis of information on the plurality of items relating to an attribute of a worker, an attribute of work, or an attribute of a combination of a worker and work related to the data at normal time; and determine whether or not information on each of the plurality of items related to the data at time of saturation satisfies the threshold, and determine priority order of the plurality of items on the basis of a result of the determination.

### TECHNICAL FIELD

Embodiments of the present invention relate to a work assignment support device, a work assignment support method, and a program.

### BACKGROUND ART

To manage assignment of work to workers, work assignment tables are often created. Conventionally, an assigner (including a tool such as computer software) creates a work assignment table in consideration of individual skills of workers, work properties, and the like.

Here, when the amount of work is increased more than an amount that can be handled by a worker (at time of work saturation), a minimum target quality (cut-off value) that can be achieved at normal time cannot be achieved, so that it is necessary to allow some items on the basis of priority order, such as relaxing requirements of a skill level of the worker. In such work assignment at the time of work saturation, for example, which item should be prioritized from the viewpoint of safety depends on intuition and experience of the assigner. In addition, items to be considered are complicated, and work efficiency also needs to be considered, and thus it has been difficult to create clear criteria that can cope with various situations. For that reason, there has been some variation in quality of the assignment table.

As an example of a method of coping with such a problem, a method of determining the priority order of consideration items using a mathematical optimization technology on the basis of the minimum target quality (cut-off value) has been devised (see, for example, Patent Literature 1).

### CITATION LIST

### Patent Literature

Patent Literature 1: JP 2016-143121 A

### SUMMARY OF INVENTION

### Technical Problem

However, the conventional method can be applied only in a case where a requirement level (cut-off value) such as product performance is uniquely determined, and the priority order of the consideration items cannot be determined when a target requirement level is not reached as at the time of work saturation described above. In addition, in a case where mathematical optimization is used, a mathematical optimization engineer is required.

The present invention has been made in view of the above circumstances, and an object thereof is to provide a work assignment support technology capable of presenting clear information for supporting assignment work even when the amount of work is saturated without depending on intuition or experience of an assigner.

### Solution to Problem

To solve the above problem, a work assignment support device according to one aspect of the present invention includes: a data classification unit that classifies past assignment table data indicating assignment of work to workers into data at normal time and data at time of saturation by comparison between a workable amount determined from a number of the workers and an actual amount of work; a threshold setting unit that sets a threshold to each of a plurality of items on the basis of information on the plurality of items relating to an attribute of a worker, an attribute of work, or an attribute of a combination of a worker and work related to the data at normal time; and a priority order determination unit that makes determination whether or not information on each of the plurality of items related to the data at time of saturation satisfies the threshold, and determines priority order of the plurality of items on the basis of a result of the determination.

### Advantageous Effects of Invention

According to the work assignment support device according to one aspect, the past work assignment table data is classified into the data at normal time and the data at time of saturation by comparison between the workable amount and the actual amount of work. Then, on the basis of the data at normal time in the past assignment table data, the threshold is set for each of the plurality of items relating to the attribute of the worker, the attribute of the work, or the attribute of the combination of the worker and the work related to the data at normal time. Next, on the basis of the data at time of saturation in the past assignment table data, the priority order of the items is determined on the basis of whether or not each item related to the data at time of saturation satisfies each threshold set on the basis of the data at normal time.

That is, the priority order of the items to be considered is automatically determined on the basis of the past work assignment table data by the work assignment support device as described above. The determined priority order is information indicating which item should be preferentially considered and which item should be allowed when work assignment is performed at the time of work saturation. On the basis of the priority order determined by the work assignment support device, an assigner can easily determine which item should be preferentially considered and which item should be allowed at the time of work saturation without depending on intuition or experience.

As described above, according to the above aspect, it is possible to provide the work assignment support technology capable of presenting clear information for supporting the assignment work even when the amount of work is saturated without depending on intuition or experience of the assigner.

### BRIEF DESCRIPTION OF DRAWINGS

FIG. 1 is a block diagram illustrating a functional configuration example of a work assignment support device according to an embodiment.

FIG. 2 is a block diagram illustrating a hardware configuration example of the work assignment support device according to the embodiment.

FIG. 3 is a flowchart illustrating an overall processing procedure and processing details by the work assignment support device illustrated in FIG. 1.

FIG. 4 is a flowchart illustrating a procedure of assignment table data classification processing in the processing illustrated in FIG. 3.

FIG. 5 is a flowchart illustrating a procedure of reference threshold setting processing in the processing illustrated in FIG. 3.

FIG. 6 is a flowchart illustrating a procedure of data-at-time-of-saturation division processing in the processing illustrated in FIG. 3.

FIG. 7 is a flowchart illustrating a procedure of prioritization processing in the processing illustrated in FIG. 3.

FIG. 8 is a flowchart illustrating a procedure of allowable value setting processing in the processing illustrated in FIG. 3.

FIG. 9 is a diagram illustrating an application example of the work assignment support device according to the embodiment.

FIG. 10 is a diagram illustrating a calculation image of a movement distance.

FIG. 11 is a diagram illustrating an example of a threshold of an item relating to the movement distance.

FIG. 12 is a diagram illustrating a calculation image of a threshold of an item relating to a skill level.

FIG. 13 is a diagram illustrating a calculation image of a threshold of an item relating to worker training.

FIG. 14 is a diagram for explaining a relationship between a worker and an area.

FIG. 15 is a diagram illustrating a calculation image of a threshold of an item relating to the relationship between the worker and the area.

FIG. 16 is a diagram for explaining a relationship between a worker and a construction company.

FIG. 17 is a diagram illustrating a calculation image of a threshold of an item relating to the relationship between the worker and the construction company.

FIG. 18 is a diagram illustrating a division image of data at time of saturation depending on a degree of work saturation.

FIG. 19 is a diagram illustrating an example of determined priority order.

FIG. 20 is a diagram illustrating a determination image of an allowable limit.

FIG. 21 is a diagram illustrating a setting image of an allowable value.

FIG. 22 is a diagram illustrating an example of a set allowable value.

FIG. 23 is a diagram illustrating an application operation example.

### DESCRIPTION OF EMBODIMENTS

Hereinafter, embodiments according to the present invention will be described with reference to the drawings. Note that, hereinafter, the same or similar reference numerals will be given to the same or similar elements as those already described, and redundant description will be basically omitted.

### An Embodiment

### (1) Outline

First, an outline of an embodiment will be described.

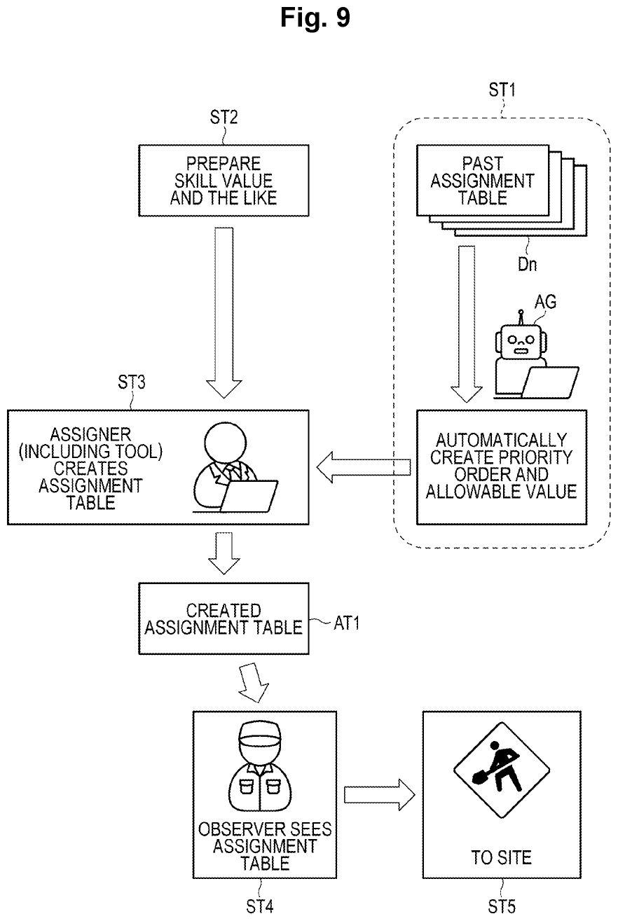

FIG. 9 illustrates an application example of a work assignment support device according to the embodiment in work assignment work. In conventional work assignment work, for example, as shown in ST2 to ST5, a skill value necessary for work and skill values of workers are prepared in advance (ST2), and an assigner (including a tool) creates an assignment table AT1 while considering individual skills and the like (ST3). Then, an observer sees the created assignment table (assignment plan) AT1 (ST4), goes to a site, and assigns work to the workers (ST5).

Here, at the time of work saturation when the number of pieces of work or the amount of work is tight with respect to the number of workers, it is necessary to relax the level of any requirement when assigning the work. Here, “at the time of work saturation” refers to a situation in which the actual number of pieces of work or the actual amount of work (hereinafter, it is simply referred to as “workable amount” or “actual workable amount”.) exceeds the number of pieces of work or the amount of work (hereinafter, it is referred to as “amount of work” or “actual amount of work”.) that can actually be handled by the worker. In addition, here, the fact that the actual amount of work exceeds the actual workable amount is referred to as “saturation” or “work saturation”. Saturation may be known before assignment of work, or saturation may occur due to sudden changes in situations such as absence of a worker, an accident, or a disaster.

In the conventional work, which item should be preferentially considered and which item should be allowed at the time of such work saturation has depended on intuition and experience of the assigner. For that reason, for example, even if a policy of placing importance on safety or placing importance on work efficiency is determined, there has been no clear criteria for determining which item and how much should be specifically allowed at the time of work saturation, and variation has occurred in the quality of assignment. If priority order or an allowable amount is wrong, problems such as decrease in safety and work efficiency may occur. In addition, it is also difficult for an assigner with less experience to determine whether the assignment table created by the assigner is good or bad.

Although it is conceivable to set a cut-off point (threshold) for each of consideration items at normal time (workable range) and determine the priority order of the consideration item using a mathematical optimization technology on the basis of the minimum target quality (cut-off value), it is difficult to determine a target value (for example, a clear minimum target quality value such as “product quality is greater than or equal to 40 points in total”) to be the goal while requiring a mathematical optimization engineer.

Thus, in the embodiment, as illustrated in FIG. 9, a work assignment support device AG gives the priority order to the consideration item on the basis of past assignment table data Dn, and automatically calculates an allowable value of each item (ST1). At the time of work saturation, the assigner can create a work assignment table using the determined priority order and allowable value without relying on intuition or experience (ST3). As a result, even an assigner with less experience can create a high-quality assignment table, and homogenization and high quality of the assignment table can be achieved.

Note that, here, as a premise, it is assumed that the past assignment table has been converted into data (electronized), and an assignment table in which an accident has occurred is not accumulated and is not used. In addition, it is assumed that the amount of work that each worker can perform during the normal working hours is determined.

### (2) Configuration

(2-1) Functional Configuration

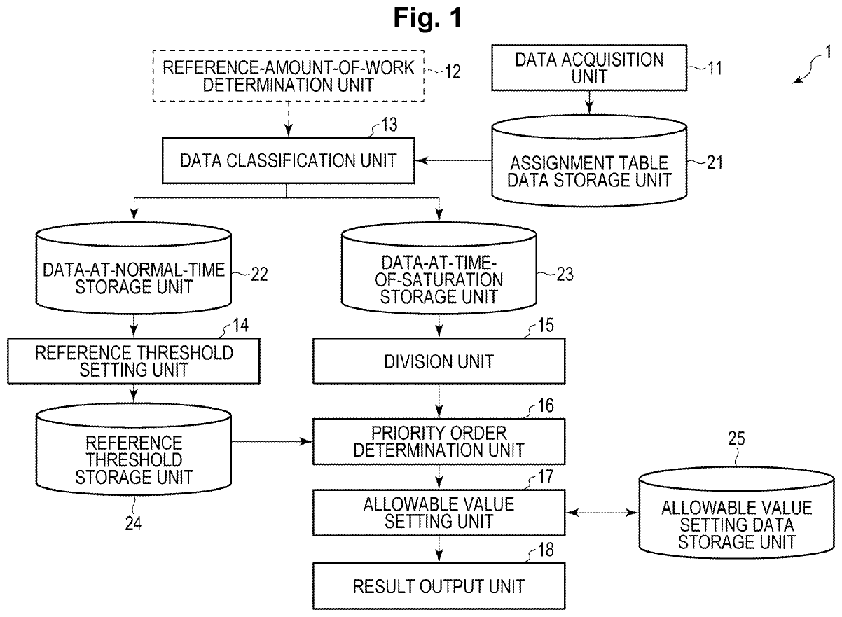

FIG. 1 is a block diagram illustrating an example of a functional configuration of a work assignment support device 1 according to the embodiment. The work assignment support device 1 is, for example, a computer such as a personal computer or a server computer, and determines priority order of items to be considered on the basis of past assignment table data. The work assignment support device 1 can further determine an allowable value of each item.

The work assignment support device 1 according to the embodiment includes, as processing units, a data acquisition unit 11, a reference-amount-of-work determination unit 12, a data classification unit 13, a reference threshold setting unit 14, a division unit 15, a priority order determination unit 16, an allowable value setting unit 17, and a result output unit 18. The work assignment support device 1 also includes, as storage units, an assignment table data storage unit 21, a data-at-normal-time storage unit 22, a data-at-time-of-saturation storage unit 23, a reference threshold storage unit 24, and an allowable value setting data storage unit 25.

The data acquisition unit 11 acquires past assignment table data indicating assignment of work to the worker, and accumulates the past assignment table data in the assignment table data storage unit 21. The data acquisition unit 11 can acquire the past assignment table data, for example, by receiving information from another communicable device via a network or by reading information from an external memory such as a USB memory. The past assignment table data includes information on an actually used work assignment result, and reflects a changed work assignment result in a case where a change is made due to absence of the worker, a sudden accident, disaster, or the like. In addition, the past assignment table data includes information on an item to be considered at the time of assignment. Specifically, the information on the item to be considered is arbitrarily designated in advance by the user (including an administrator, a designer, an assigner, and the like) of the work assignment support device 1, and can include information on a plurality of items relating to the attribute of the worker, the attribute of the work, or the attribute of the combination of the worker and the work. The attribute of the worker includes, for example, a skill level of the worker. The attribute of the work includes, for example, a movement distance to a work site, a degree of difficulty of construction, quality of a construction company, and the like. The attributes relating to the combination of the worker and the work include, for example, a relationship between the worker and the construction company, compatibility between the worker and a work area, compatibility between the worker and a vehicle to be used in the work, and a relationship between the worker (operator) and a customer. However, the above description is merely an example, and the attribute of the worker, the attribute of the work, and the attribute of the combination of the worker and the work do not need to be distinguished from each other. For example, the skill level can also be said to be an attribute of the worker or an attribute of a combination of specific work and the worker. The past assignment table data may be acquired separately from the information on the item to be considered, and may be accumulated and managed in association with each other by a worker ID, a work ID, and the like.

The reference-amount-of-work determination unit 12 determines “the number of pieces of work or amount of work that can be handled per worker” (hereinafter, it is referred to as a “reference amount of work”.). For example, the reference-amount-of-work determination unit 12 determines different reference amounts of work depending on a degree to which the worker is trained, such as three pieces of work per person per day for a general worker and one piece of work per person per day for a trainee. The reference-amount-of-work determination unit 12 is not an essential component of the work assignment support device 1, and may be omitted. The reference-amount-of-work determination unit 12 may use a value input by the user or the like of the work assignment support device 1 as the reference amount of work. Alternatively, the reference-amount-of-work determination unit 12 may determine the reference amount of work by reading information stored in advance in a storage unit (not illustrated).

The data classification unit 13 performs processing of sorting the past assignment table data indicating assignment of the work to the worker into assignment table data at “normal time” (hereinafter, it is also referred to as “data at normal time”.) and assignment table data at “time of saturation” (hereinafter, it is also referred to as “data at time of saturation”.), depending on a ratio between the amount of work and the workable amount. Here, the processing of sorting the past assignment table data into the data at normal time and the data at time of saturation is also referred to as “classification”. In the embodiment, the data classification unit 13 reads the past assignment table data one by one, determines whether or not the actual amount of work exceeds the actual workable amount, and classifies the data as “data at normal time” in a case where the actual amount of work does not exceed the actual workable amount, and classifies the data as “data at time of saturation” in a case where the actual amount of work exceeds the actual workable amount.

The reference threshold setting unit 14 sets a reference value (hereinafter, it is referred to as a “reference threshold”.) to each item on the basis of information on the item to be considered relating to the attribute of the worker, the attribute of the work, or the attribute of the combination of the worker and the work related to the data at normal time in the past assignment table data. For example, in the case of focusing on the skill level of the worker as an item, the reference threshold setting unit 14 reads the skill level of the worker assigned to the specific work from the data at normal time when the amount of work is not saturated, and sets the reference threshold on the basis of the read skill level. According to the embodiment, the reference threshold setting unit 14 sets the reference threshold by using the maximum value or the minimum value of each item in the read data at normal time. In a case where the information on the item is other than a numerical value (for example, skill level A/B/C, presence or absence of qualification, or the like), the reference threshold setting unit 14 can obtain the maximum value or the minimum value by quantifying the information. Furthermore, here, the “reference threshold” can include information designating a range or a condition, such as “skill level A or higher”. Details of reference threshold setting will be further described below.

The division unit 15 performs processing of further dividing the data at time of saturation in the past assignment table data into a plurality of sections depending on a degree of excess of the amount of work with respect to the workable amount (hereinafter, the degree is referred to as a “degree of work saturation”.). The division unit 15 is not an essential component of the work assignment support device 1, and may be omitted.

The priority order determination unit 16 gives priority order to the plurality of items by performing comparison with a set reference threshold on the basis of the data at time of saturation in the past assignment table data. Here, it is meant that an item having a higher priority order is an item that should not be allowed (a requirement should not be relaxed). The priority order determination unit 16 makes determination whether or not each of items related to the data at time of saturation satisfies a reference threshold, and determines the priority order of the items on the basis of a result of the determination. According to the embodiment, the number of pieces of data that do not satisfy the reference threshold is calculated for each of the plurality of items related to the data at time of saturation, and the priority order of the items is determined so that an item having a larger number of pieces of data that do not satisfy the reference threshold has a lower priority order. The priority order determination unit 16 can also perform priority order determination processing described above for each section divided by the division unit 15. Details of the priority order determination processing will be further described below.

The allowable value setting unit 17 specifies information on an item having the highest priority order among items not satisfying the reference threshold, for each piece of the data at time of saturation in the past assignment table data, and sets an allowable value of each item on the basis of the specified information. According to the embodiment, the allowable value setting unit 17 specifies the information on the item having the highest priority order among the items not satisfying the reference threshold, for each of pieces of the data at time of saturation, and sets the allowable value on the basis of information having the largest difference (deviation) from the reference threshold among the specified information. In other words, the allowable value setting unit 17 determines whether or not each item satisfies the reference threshold, for each of pieces of the data at time of saturation in descending order of the priority order, and records a value when the reference threshold is no longer satisfied as “allowable value setting data” in the allowable value setting data storage unit 25. The allowable value setting unit 17 repeats the processing as many times as the number of pieces of data, and sets a value having the largest deviation from the reference threshold as the allowable value. The “allowable value” can include information designating a range or a condition, for example, “skill level B or higher”. The allowable value setting unit 17 can also perform allowable value setting processing described above for each section divided by the division unit 15. Details of the allowable value setting processing will be further described below.

The result output unit 18 performs processing of outputting the determined priority order and allowable value. For example, to present the determined priority order and allowable value to the user, the result output unit 18 generates display data and outputs the display data to an output device such as a display.

The assignment table data storage unit 21 stores the past assignment table data acquired by the data acquisition unit 11. As described above, it is assumed that the past assignment table data reflects an assignment result actually used in the past, and the assignment table data when an accident occurs is not accumulated in the assignment table data storage unit 21.

The data-at-normal-time storage unit 22 stores the data at normal time classified by the data classification unit 13.

The data-at-time-of-saturation storage unit 23 stores the data at time of saturation classified by the data classification unit 13.

The reference threshold storage unit 24 stores the reference threshold of each item set by the reference threshold setting unit 14 on the basis of the data at normal time.

The allowable value setting data storage unit 25 stores allowable value setting data recorded in a process of setting the allowable value by the allowable value setting unit 17.

The storage units 21 to 25 are not essential components of the work assignment support device 1, and may be omitted or may be provided outside the work assignment support device 1.

(2-2) Hardware Configuration

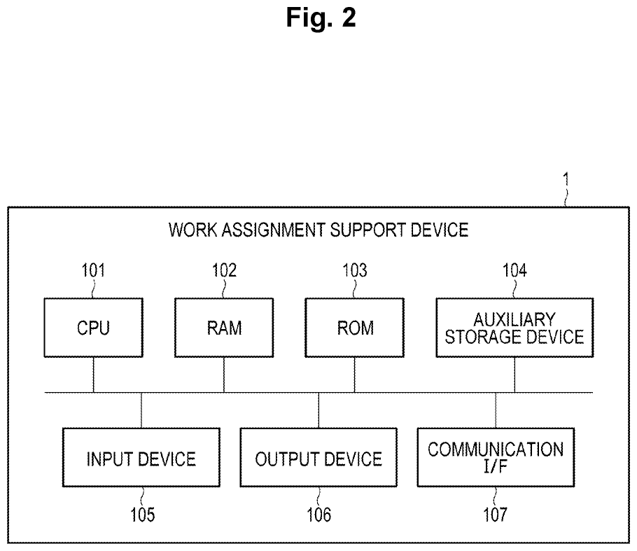

FIG. 2 is a block diagram illustrating an example of a hardware configuration of the work assignment support device 1. The work assignment support device 1 includes a central processing unit (CPU) 101, a random access memory (RAM) 102, a read only memory (ROM) 103, an auxiliary storage device 104, an input device 105, an output device 106, and a communication interface (communication I/F) 107, which are connected to each other via a bus.

The CPU 101 is an example of a processor, and controls overall operation of the work assignment support device 1. The CPU 101 deploys a program stored in the ROM 103 or the auxiliary storage device 104 on the RAM 102, and executes the program, thereby operating as the data acquisition unit 11, the reference-amount-of-work determination unit 12, the data classification unit 13, the reference threshold setting unit 14, the division unit 15, the priority order determination unit 16, the allowable value setting unit 17, and the result output unit 18 described above. The CPU 101 may be implemented in various other form including an integrated circuit such as an application specific integrated circuit (ASIC) or a field-programmable gate array (FPGA). In addition, the CPU 101 may include a plurality of processors.

The auxiliary storage device 104 can be, for example, a hard disk drive (HDD) or a solid state drive (SDD). The auxiliary storage device 104 non-transitorily stores a program executed by the CPU 101, setting data necessary for executing the program, and the like. The auxiliary storage device 104 can also function as a storage unit including the assignment table data storage unit 21, the data-at-normal-time storage unit 22, the data-at-time-of-saturation storage unit 23, the reference threshold storage unit 24, and the allowable value setting data storage unit 25 described above.

The input device 105 includes, for example, a keyboard or the like for an assigner (user) or the like who assigns work to a worker to input an instruction to the work assignment support device 1. In addition, the input device 105 can include a reader for reading data to be stored in the storage unit from a memory medium such as a USB memory, and a disk device for reading the data from a disk medium. Furthermore, the input device 105 may include an image scanner with or without an optical character recognition (OCR) function.

The output device 106 includes a display that displays output data to be presented to the assigner from the work assignment support device 1, a printer that prints the output data, and the like. In addition, the output device 3 can include a writer for writing data to be input to another information processing device such as a personal computer or a smartphone to a memory medium such as a USB memory, and a disk device for writing such data to a disk medium.

The communication interface 107 is an interface for communicating with an external device. The communication interface 107 includes, for example, an interface for wireless or wired local area network (LAN) communication. The work assignment support device 1 can receive, for example, past assignment table data from a computer used by an assigner or transmit a set priority order, an allowable value, and the like to a computer used by the assigner via a network such as the Internet by the communication interface 107.

However, the above description is merely an example, and in a specific hardware configuration of the work assignment support device 1, a component may be appropriately omitted, replaced, or added depending on the embodiment.

### (3) Operation

Next, an example will be described of information processing operation by the work assignment support device 1 configured as described above.

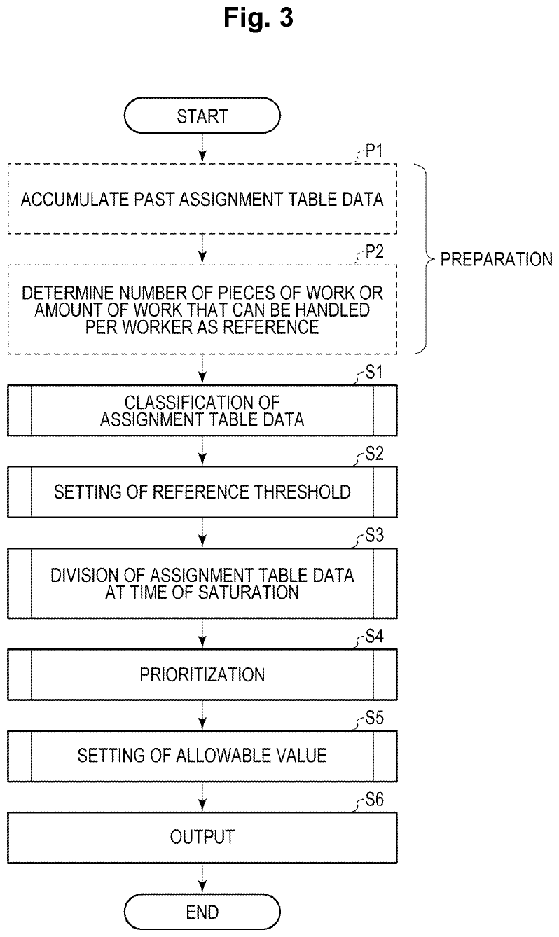

FIG. 3 is a flowchart illustrating an example of a processing procedure and processing details of the work assignment support device 1.

(3-1) Preparation

First, as preparation step P1, the work assignment support device 1 acquires past assignment table data by the data acquisition unit 11 and accumulates the data in the assignment table data storage unit 21. The accuracy can be increased as the number of pieces of past assignment table data used for subsequent processing is larger. As described above, the assignment table data includes information indicating assignment of work to a worker. The assignment table data also includes or is associated with information representing an attribute of the work, an attribute of the worker, or an attribute relating to a combination of the work and the worker as an item to be considered.

As preparation step P2, the work assignment support device 1 determines “the number of pieces of work or the amount of work that can be handled per worker” (reference amount of work) by the reference-amount-of-work determination unit 12. For example, the reference-amount-of-work determination unit 12 can determine different reference amounts of work depending on a degree to which the worker is trained, such as three pieces of work per person per day for a general worker and one piece of work per person per day for a trainee.

(3-2) Classification of Assignment Table Data

Next, in step S1, the work assignment support device 1 reads the assignment table data from the assignment table data storage unit 21 by the data classification unit 13, and executes classification of the data. In step S1, a target is to determine an assignment table (that is, an assignment table at the normal time) as a reference on the basis of the amount of work that can be handled in one day. As a premise, it is assumed that the reference number of assignments and amount (the number of pieces and amount of work that can be handled for one day and AM/PM) for workers are determined.

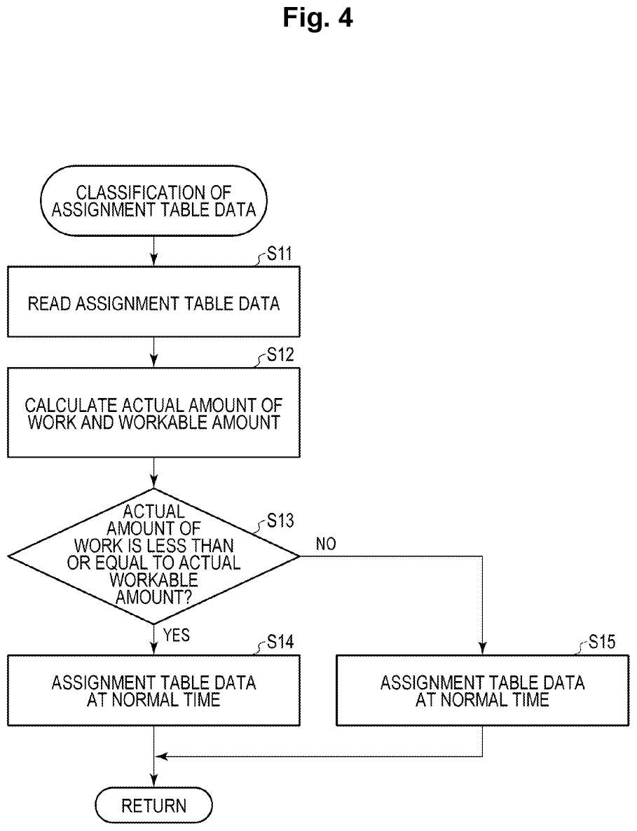

FIG. 4 illustrates details of assignment table data classification processing by the data classification unit 13.

First, in step S11, the data classification unit 13 reads the past assignment table data from the assignment table data storage unit 21.

Next, in step S12, the data classification unit 13 calculates an actual amount of work and an actual workable amount for each of pieces of read assignment table data. The actual amount of work is calculated, for example, by summing the number of pieces of work included in the assignment table data. The actual workable amount represents the maximum amount of work (the number of pieces of work) that can actually be handled in one day, and is calculated on the basis of information on the worker who has actually performed the work and the reference amount of work determined by the reference-amount-of-work determination unit 12. For example, in a case where it is determined that the reference amount of work is three pieces of work per person per day for the general worker and one piece of work per day for the trainee, if four general workers and one trainee actually perform the work, the maximum workable amount (maximum number) per day can be calculated as:

3 pieces of work/day/person×4 persons+1 piece of work/day/person×1 person=13 pieces of work/day

In step S13, the data classification unit 13 determines whether or not the actual amount of work is less than or equal to the actual workable amount (whether or not the actual workable amount is exceeded) for each of pieces of the read assignment table data. In a case where the actual amount of work is less than or equal to the actual workable amount (YES), the data classification unit 13 determines the assignment table data as assignment table data at “normal time” and stores the assignment table data in the data-at-normal-time storage unit 22. In the above example, in a case where the actual amount of work is less than or equal to 13 pieces of work (0 to 13 pieces of work), it is determined as data at normal time.

On the other hand, in step S13, in a case where the actual amount of work exceeds the actual workable amount (NO), the data classification unit 13 determines that the assignment table data is assignment table data at “time of saturation” and stores the assignment table data in the data-at-time-of-saturation storage unit 23. In the above example, a case where the actual amount of work exceeds 13 pieces of work (greater than or equal to 14 pieces of work) or a case where the worker is absent corresponds to the “time of saturation”.

(3-3) Reference Threshold Setting

Next, in step S2 of FIG. 3, the work assignment support device 1 performs reference threshold setting on the basis of the assignment table serving as the reference, that is, the data at normal time, by the reference threshold setting unit 14.

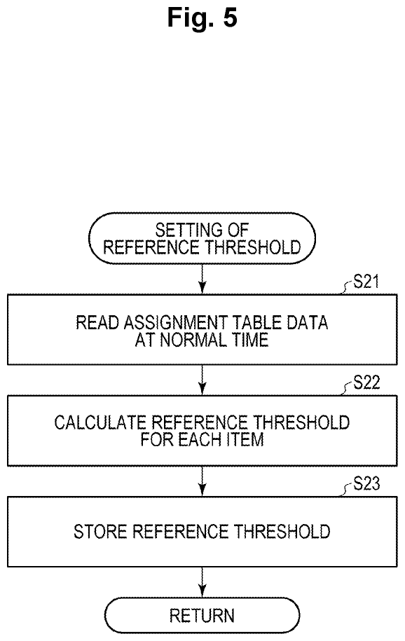

FIG. 5 illustrates details of reference threshold setting processing by the reference threshold setting unit 14.

First, in step S21, the reference threshold setting unit 14 reads data at normal time from the data-at-normal-time storage unit 22.

In step S22, the reference threshold setting unit 14 calculates a reference threshold of each item. As described above, the items to be considered are designated in advance, and the information on each item is included in or associated with each of pieces of assignment table data. The reference threshold setting unit 14 records information on each item for each of pieces of the data at normal time, and calculates the reference threshold by specifying the maximum value or the minimum value. Which one of the maximum value or the minimum value should be adopted is also designated in advance for each item by the user or the like.

Next, in step S23, the reference threshold setting unit 14 stores the reference threshold calculated for each item in the reference threshold storage unit 24.

Hereinafter, a specific calculation example of the reference threshold in step S22 will be further described. However, the following is merely an example, and the embodiment is not limited to the exemplified items.

(3-3-1) Threshold Item Based on Movement Distance

To increase work efficiency, it is conceivable to set a threshold regarding the movement distance.

For example, the reference threshold setting unit 14 reads the data at normal time, records a distance between work bases for each of pieces of the data, calculates a total value of the movement distance per worker within the maximum number (reference amount of work) that can be handled in one day, and sets the maximum value as the threshold.

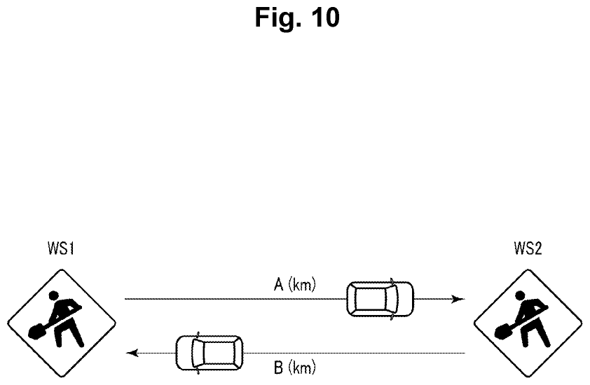

FIG. 10 illustrates an example of a calculation image of the movement distance. The reference threshold setting unit 14 records a one-way distance (example, A km) or a round-trip distance (example, A+B km, A and B may be the same path or different paths) between two work bases WS1 and WS2 for each of pieces of the data at normal time, and extracts a maximum value thereof as a threshold.

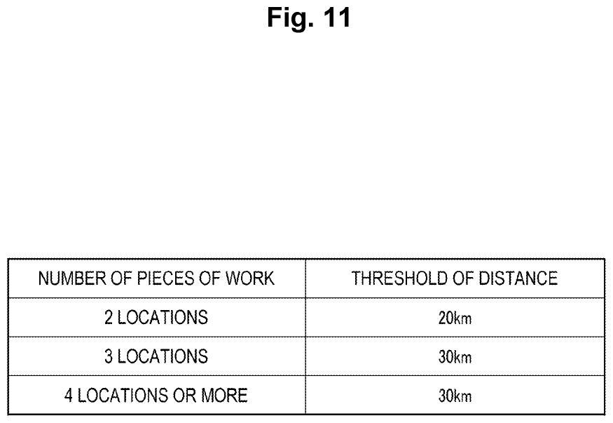

FIG. 11 illustrates an example of a threshold of the distance set by the reference threshold setting unit 14. A maximum movement distance is set depending on the number of pieces of work, and for example, in this example, the maximum movement distance is set to 20 km when the number of pieces of work is two locations, 30 km when the number of pieces of work is three locations, and 30 km when the number of pieces of work is four locations.

(3-3-2) Threshold Item Based on Skill Level

To reduce a possibility of an accident, it is conceivable to set a threshold of a skill level depending on work. This is based on the assumption that a cause of the accident may be a mismatch between a “skill level of a worker” and “work”. As a premise, it is assumed that the skill level of each worker is known in advance, and a degree of difficulty of work is quantified. The threshold based on the skill level can also be rephrased as a threshold based on the degree of difficulty.

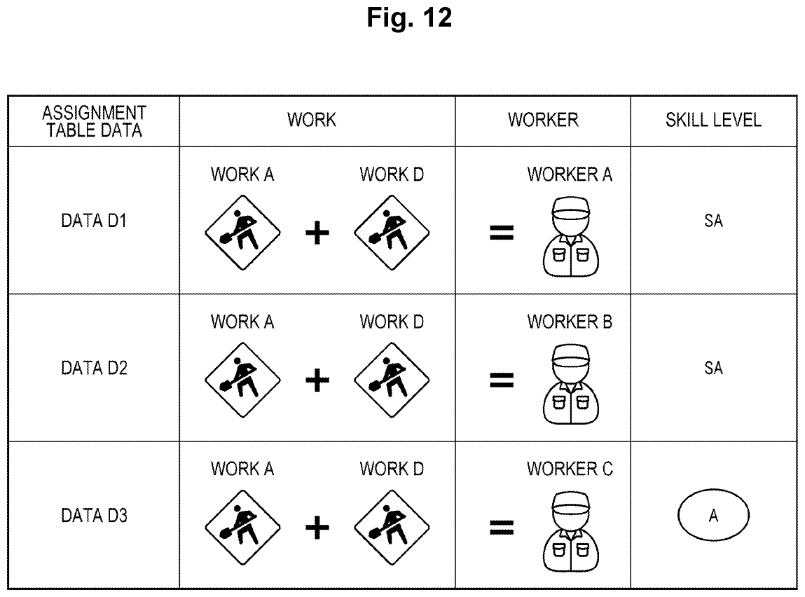

FIG. 12 illustrates an example of an image of threshold setting based on the skill level. In this example, a case where two pieces of work (work A+work D) are assigned to a worker will be considered. For example, the reference threshold setting unit 14 extracts a worker to which “work A+work D” is assigned from each of pieces of the data at normal time, and records a skill level of the extracted worker. The reference threshold setting unit 14 can set the lowest skill level among recorded skill levels as a threshold. In the example of FIG. 12, the skill level of a worker A extracted from data D1 is “SA”, the skill level of a worker B extracted from data D2 is “SA”, and the skill level of a worker C extracted from data D3 is “A”. In addition, here, it is assumed that the level A is lower than the level SA. In this case, the reference threshold setting unit 14 sets the “level A” as the threshold for the “work A+work D”.

Note that, for example, in a case where joint work is performed, such as a case where the “work A+work D” is assigned to two workers, the threshold setting can be performed in the same manner as described above by comparing skill levels of the two workers and adopting a level of a worker with a higher skill level. The same applies to a case where joint work is performed by three or more people.

(3-3-3) Threshold for Placing Importance on Worker Training

Considering efficiency and safety of the entire work, it is common to assign a highly difficult work to a highly skilled person. However, considering worker training, it is also necessary to cause workers to carefully perform work that is more difficult than holding skills. On the other hand, there is a problem even if the work is too difficult. Thus, it is conceivable to set a threshold for an assignment plan for which worker training is not considered.

It is assumed that a “trainee” is a worker whose bit of “trainee” is set in advance among workers with the skill level “C”. It is assumed that at least one piece of “work for training” is assigned to each of trainees. Similarly, it is assumed that a “label for training” is attached (or a bit indicating that the work is work for training is set) to “work for trainees”, that is, work that is desired to be performed by the trainees in pieces of work. When the work assigned to the “trainee” is viewed, a case where the work with the “label for training” is assigned is regarded as a case where “training is considered”.

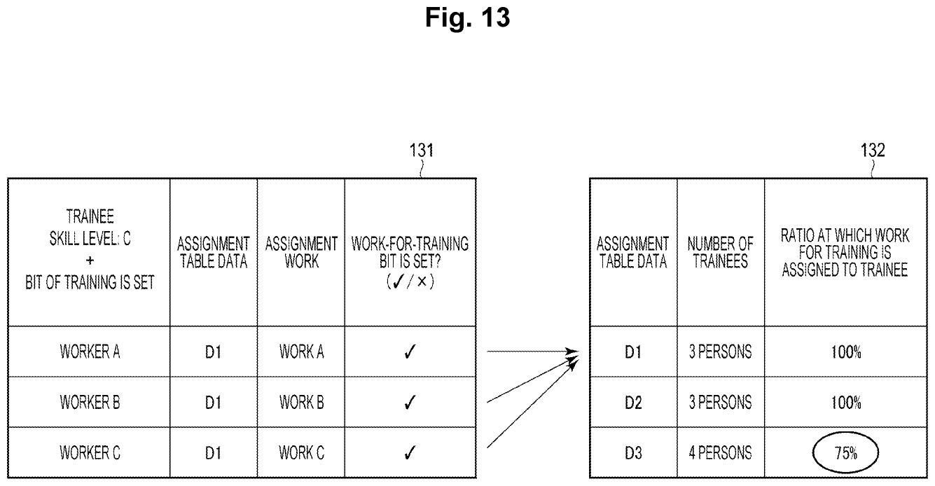

FIG. 13 illustrates an example of an image of threshold setting in the case of placing importance on worker training. A table 131 on the left side shows an example of information included in the assignment table data D1, and a table 132 on the right side shows a ratio at which the work for training is assigned to the trainee, the ratio being calculated from the assignment table data D1, D2, and D3 (Details of the assignment table data D2 and D3 are not illustrated. The same applies to the subsequent drawings.).

In this example, the reference threshold setting unit 14 records, from the data at normal time D1, at what ratio “work for training: work for a bit for training is set” is assigned to “the total number of pieces of work assigned to the trainee”, and sets the minimum ratio as the reference threshold.

In FIG. 13, the assignment table data D1 includes three persons of the worker A, the worker B, and the worker C as the trainee. Work A is assigned to the worker A, and a work-for-training bit is set for the work A. That is, the work for training is assigned to the worker A. Similarly, work for training B is assigned to the worker B, and work for training C is assigned to the worker C. Thus, in the assignment table data D1, the ratio of the “work for training” to “the total number of pieces of work assigned to the trainee” is calculated as follows:

(the number of pieces of work for training)/(the total number of pieces of work assigned to the trainee)=3/3=100%

For the assignment table data D2 and D3, the reference threshold setting unit 14 similarly calculates the ratio at which the work for training is assigned to the trainee, and sets the minimum value among the calculated ratios as the threshold. In this example, since “75%” obtained from the assignment table data D3 is the minimum value, the threshold is set to 75%.

(3-3-4) Threshold for Placing Importance on Area that Worker is Good at

Depending on the worker, there may be an area that the worker is good at or an area that the worker is not good at. In the area that the worker is good at, the worker can drive with fewer accidents, or can perform efficient work depending on the work environment, for example, grasping a less busy time. In addition, in the area that the worker is good at, a human relationship in a work place may be good.

Thus, it is conceivable to set a threshold for the assignment table data assigned to the area that the worker is not good at, and improving efficiency and safety. Note that it is assumed that the area that the worker is good at/the area that the worker is not good at are known in advance. The reference threshold setting unit 14 records a ratio of “the total number of pieces of work assigned to the area that the worker is good at” to “the total number of pieces of work assigned to the worker” from the assignment data at the normal time, and sets the minimum ratio as the reference threshold.

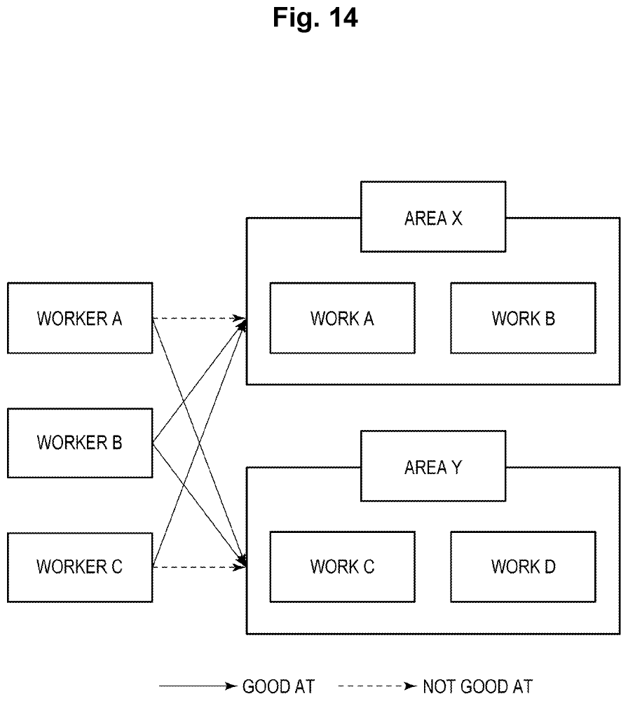

FIG. 14 illustrates an example of a relationship between an area that each worker is good at and an area that the worker is not good at. In this example, the worker A is good at an area Y (including the work C and work D), but is not good at an area X (including the work A and the work B). The worker B is good at both the area X and the area Y, and the worker C is good at the area X but not good at the area Y.

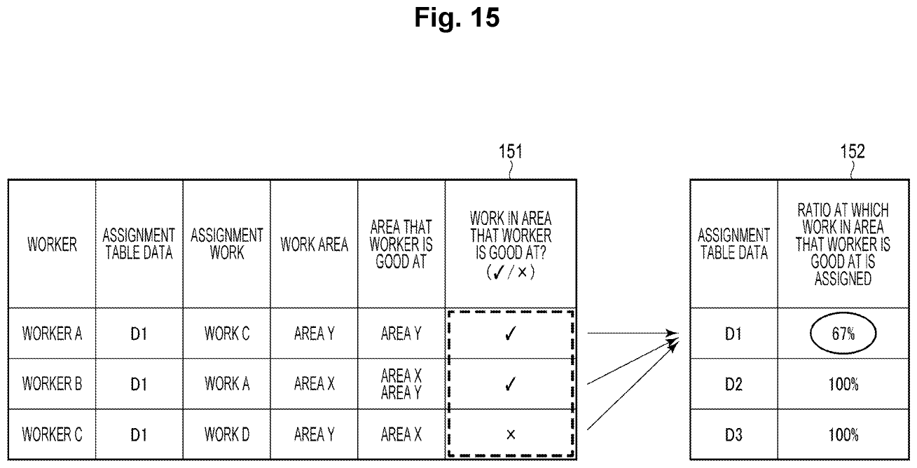

FIG. 15 illustrates an image in which a threshold is set on the basis of information of FIG. 14. A table 151 on the left side shows an example of information included in the assignment table data D1, and a table 152 on the right side shows a ratio of work in an area that the worker is good at, assigned to the worker, calculated from the assignment table data D1, D2, and D3.

In this example, in the assignment table data D1, the work C is assigned to the worker A. The work C is in the area Y and matches the area Y that the worker A is good at. A check mark indicates that the work area and the area that the worker is good at match. The work A is assigned to the worker B, and the area X for the work A matches the area X that the worker B is good at. The work D is assigned to the worker C, and the area for the work D is the area Y, which does not match the area X that the worker C is good at. The X mark indicates that the work area and the area that the worker is good at do not match. Thus, in the assignment table data D1, (the total number of pieces of work assigned to the area that the worker is good at)/(the total number of pieces of work assigned to the worker)=2/3≈67% is recorded. The reference threshold setting unit 14 performs recording similarly in the assignment table data D2 and D3, and sets 67%, which is the minimum value, as the threshold.

(3-3-5) Threshold Setting for Placing Importance on Human Relationship with Construction Company

For example, in work of supervising and observing construction of a construction company, a human relationship between a worker and the construction company is very important. In the case of a supervisor or an observer having a good relationship (reliable), an instruction is accurately transmitted to the construction company and appropriate work is performed, whereas in the case of a supervisor or an observer having a poor relationship (unreliable), there is a possibility that a construction technician in the construction company does not hear the instruction and performs unsafe work (for example, construction that needs to be performed manually and delicately is roughly performed using a construction machine).

Thus, it is enabled to set a threshold on the basis of an assignment table in which workers are combined with construction companies having poor relationships. Note that it is assumed that a relationship between each worker and a construction company (whether or not there is a good relationship) is known in advance. The reference threshold setting unit 14 records a ratio of “the total number of pieces of work assigned to the construction company compatible with the worker” to “the total number of pieces of work assigned to the worker” on the basis of the data at normal time, and sets the minimum ratio as the reference threshold value.

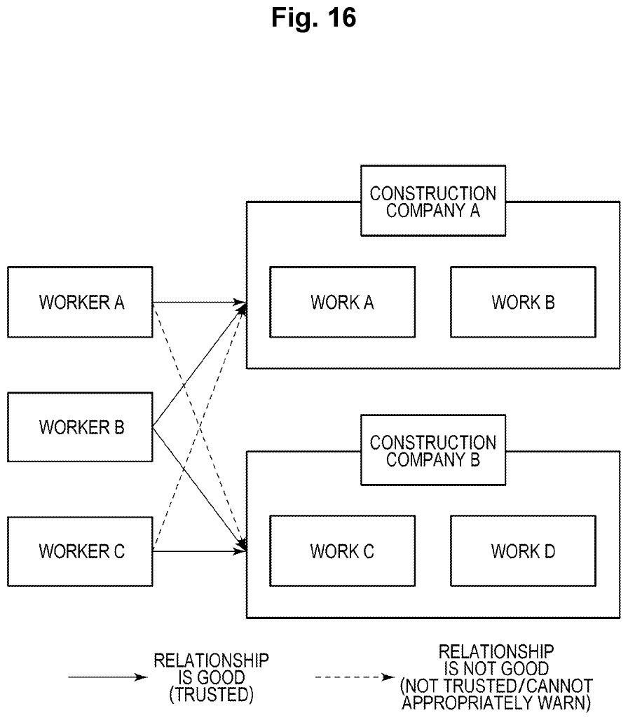

FIG. 16 is a diagram illustrating an example of a relationship between each worker and each construction company. The worker A has a good relationship with a construction company A (responsible for the work A and the work B), but has no good relationship with a construction company B (responsible for the work C and the work D). The worker B has a good relationship with both the construction company A and the construction company B. The worker C has a good relationship with the construction company B, but has no good relationship with the construction company A.

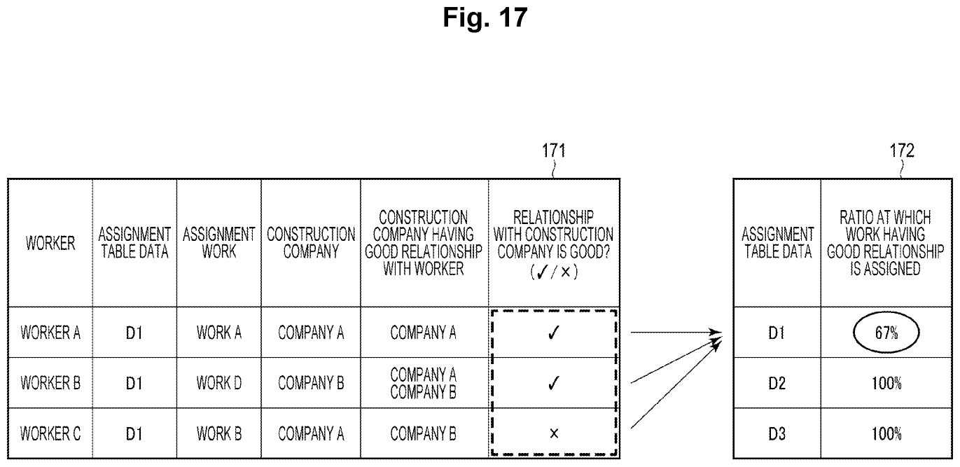

FIG. 17 illustrates an image of processing in which the reference threshold setting unit 14 sets a threshold on the basis of the relationship of FIG. 16. A table 171 on the left side shows an example of information included in the assignment table data D1, and a table 172 on the right side shows a ratio at which work having a good relationship is assigned to the worker, calculated from the assignment table data D1, D2, and D3.

In this example, in the assignment table data D1, the work A is assigned to the worker A. The construction company for the work A is the company A, and has a good relationship with the worker A. The work D of the construction company B having a good relationship with the worker B is assigned to the worker B. The work B of the construction company A having no good relationship with the worker C is assigned to the worker C. Thus, in the assignment table D1, the ratio of the assignment of the compatible work to the worker is obtained as (the total number of pieces of work assigned to the construction company having a good relationship)/(the total number of pieces of work assigned to the worker)=2/3≈67%. The reference threshold setting unit 14 performs recording similarly in the assignment table data D2 and D3, and sets 67%, which is the minimum value, as the threshold.

(3-4) Division of Data at Time of Saturation

In step S3 of FIG. 3, the work assignment support device 1 performs processing of further dividing the assignment table data at the time of work saturation depending on the degree of work saturation, by the division unit 15. By this processing, it becomes possible to set the priority order and the allowable value depending on a situation at that time. However, the processing by the division unit 15 is not essential and may be omitted.

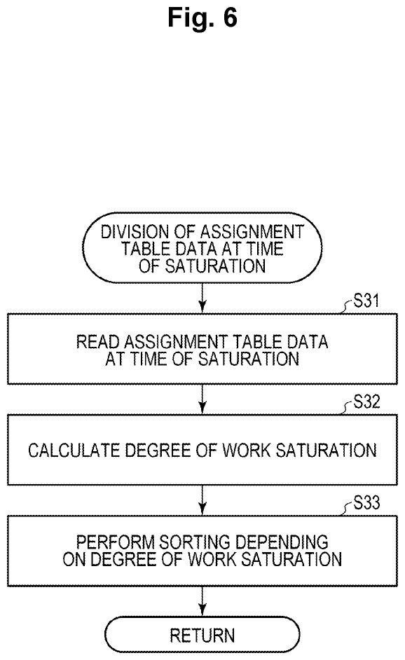

FIG. 6 illustrates details of division processing by the division unit 15.

In step S31, the division unit 15 reads the data at time of saturation from the data-at-time-of-saturation storage unit 23.

In step S32, the division unit 15 calculates the degree of work saturation for each of pieces of assignment table data.

In step S33, each of pieces of assignment table data is sorted (divided) depending on the degree of work saturation.

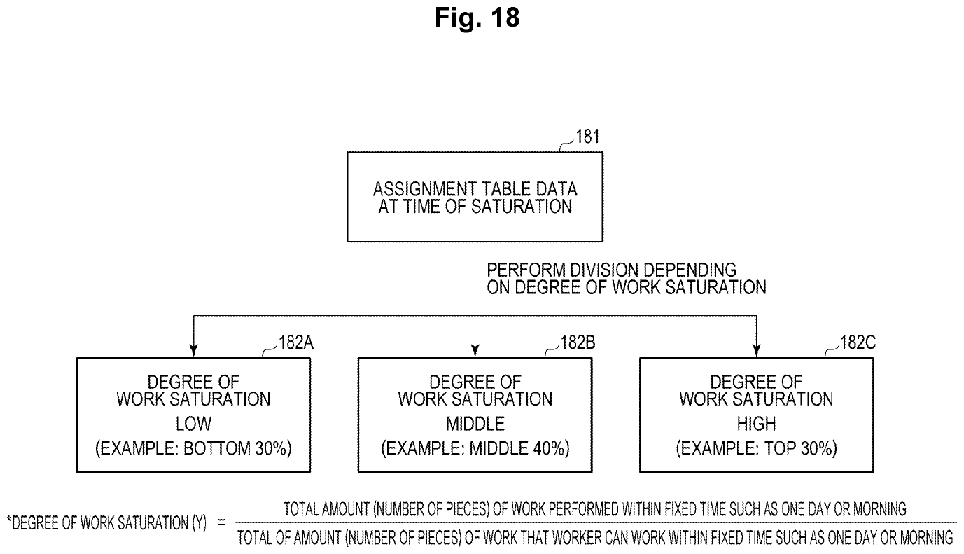

FIG. 18 illustrates an example in which the data at time of saturation is divided into three sections as an example, depending on a degree of work saturation Y. The degree of work saturation Y is defined by the following equation.

Degree of work saturation(Y)=(the total number of pieces of work performed within a fixed time such as one day or the morning)/(the total of the number of pieces of work that the worker can work within a fixed time such as one day or the morning)

The denominator in the above equation is calculated on the basis of the reference amount of work similarly to the data classification unit 13. That is, if the reference amount of work is 3 pieces of work per person per day for the general worker and 1 piece of work per day per person for the trainee, in the case of four general workers and one trainee, the total of the maximum number of pieces of work that can be performed per day is 13 pieces of work.

As described above, the case where the number of pieces of work or the amount of work is saturated corresponds to the case where the degree of work saturation (Y) exceeds 100%. For example,
(i) a case where the worker is absent due to sudden illness or the like
(ii) a case where worker training has not yet progressed, and the number of the trainees is too large with respect to the maximum number of pieces of work and the work cannot be handled
(iii) a case where special work is included and the number of workers who can work is limited, but there are not enough workers who can perform the special work
(iv) a case where emergency work is greatly expanded due to occurrence of a disaster or the like
and the like are conceivable. Although all pieces of the data at time of saturation to be processed by the division unit 15 have degrees of saturation exceeding 100%, subsequent processing is to be performed after the data is further divided depending on the degrees of saturation. In this example, depending on the calculated degree of work saturation Y, in data at time of saturation 181, the bottom 30% is sorted into a “degree of work saturation=low” (182A), the middle 40% is sorted into a “degree of work saturation=middle” (182B), and the top 30% is sorted into a “degree of work saturation=high” (182C). This is merely an example, and the ratios may be different ratios, or may be divided into two or four or more.

(3-5) Prioritization

In step S4 of FIG. 3, the work assignment support device 1 gives the priority order to the items on the basis of the data at time of saturation, by the priority order determination unit 16. In the embodiment, after the reference threshold is set by the reference threshold setting unit 14, the priority order determination unit 16 reads the assignment table data at the time of work saturation for each divided degree of saturation, and records the number of items whose values exceed the reference threshold, thereby determining the priority order. A lower priority order is given to an item having a larger number of items exceeding the reference threshold.

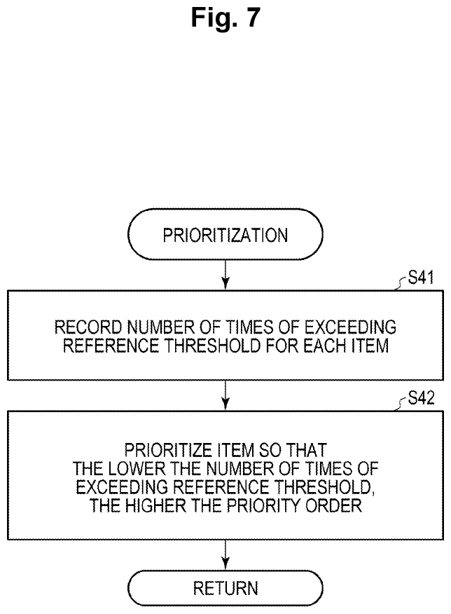

FIG. 7 illustrates details of prioritization processing by the priority order determination unit 16.

In step S41, the priority order determination unit 16 records the number of times of exceeding the reference threshold for each item.

In step S42, the priority order determination unit 16 gives the priority order to the items so that the lower the number of times of exceeding the reference threshold, the higher the priority order. It is meant that an item having a higher priority order is an item that is not desired to be allowed as much as possible. Thus, the priority order depends on data used for analysis. In a case where only data of individuals is used, it is possible to set the priority order of individuals. The more data used, the better the accuracy.

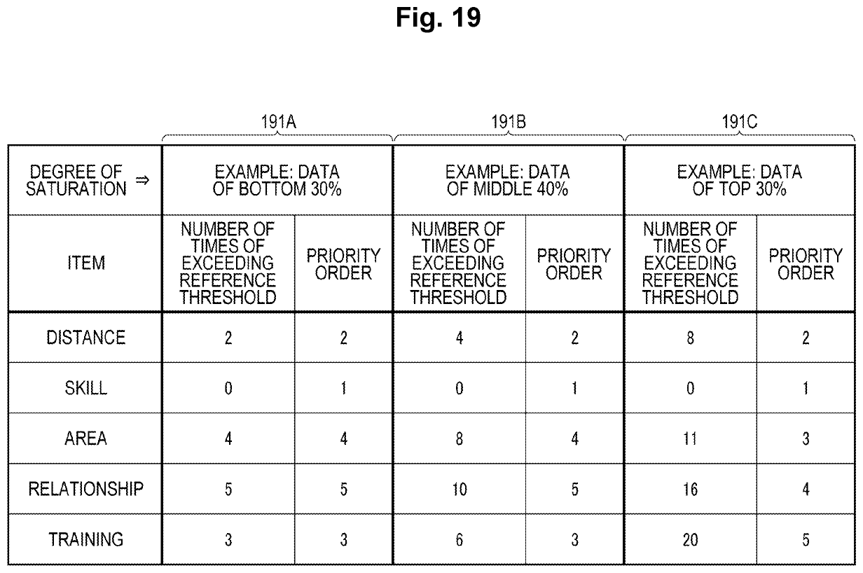

FIG. 19 illustrates an example of an image in which the priority order is determined for each of pieces of data at time of saturation divided depending on the degree of work saturation Y. A column 191A indicates data of the bottom 30%, a column 191B indicates data of the middle 40%, and a column 191C indicates data of the top 30%. The priority order determination unit 16 records the number of times of exceeding the reference threshold for each item for each of pieces of divided data at time of saturation. For example, if the reference threshold is “X≤20 km” for an item “distance”, the priority order determination unit 16 records the number of times of exceeding 20 km. In the “data of the bottom 30%”, “skill” having the smallest number of times of exceeding the reference threshold, “0 times”, is determined to have the highest priority (priority order=1), and “good relationship” having the largest number of times of exceeding the reference threshold, “5 times”, is determined to have the lowest priority (priority order=5). Similarly, the priority order determination unit 16 performs similar recording for “data of the middle 40%” and “data of the top 30%”, and gives the priority order for each item. Note that, for the “skill”, comparison is performed under the same condition (for example, “work A+work D”) as that used to calculate the reference threshold. In a case where the division processing by the division unit 15 is not performed, the priority order determination unit 16 may determine the priority order for all pieces of the data at time of saturation.

(3-6) Setting of Allowable Value

In step S5 of FIG. 3, the work assignment support device 1 sets an allowable value by the allowable value setting unit 17. It is an object to allow an assigner to accept an item with lower priority order on the assumption that all the reference thresholds cannot be satisfied at the time of work saturation. The allowable value setting unit 17 sequentially looks at items from items with higher priority order to items with lower priority order, regards a value in a case where the reference threshold is no longer satisfied as an allowable limit, and records the value as allowable value setting data. This is repeated by the number of pieces of assignment table data, and for example, a value having the largest deviation from the reference threshold is set as the allowable value.

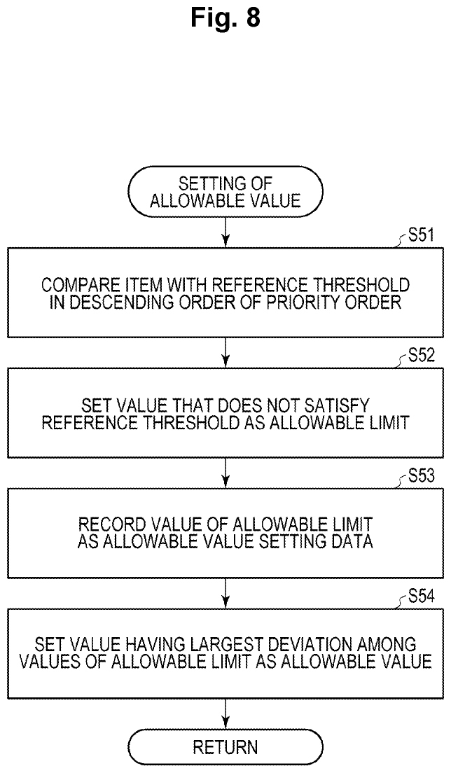

FIG. 8 illustrates details of the allowable value setting processing by the allowable value setting unit 17.

In step S51, the allowable value setting unit 17 compares the value of each item with the reference threshold in descending order of the priority order.

In step S52, when a value that does not satisfy the reference threshold is found, the allowable value setting unit 17 sets the value as the allowable limit.

In step S53, the allowable value setting unit 17 records the value of the allowable limit as the allowable value setting data in the allowable value setting data storage unit 25. The allowable value setting unit 17 repeats steps S51 to S53 by the number of pieces of data at time of saturation.

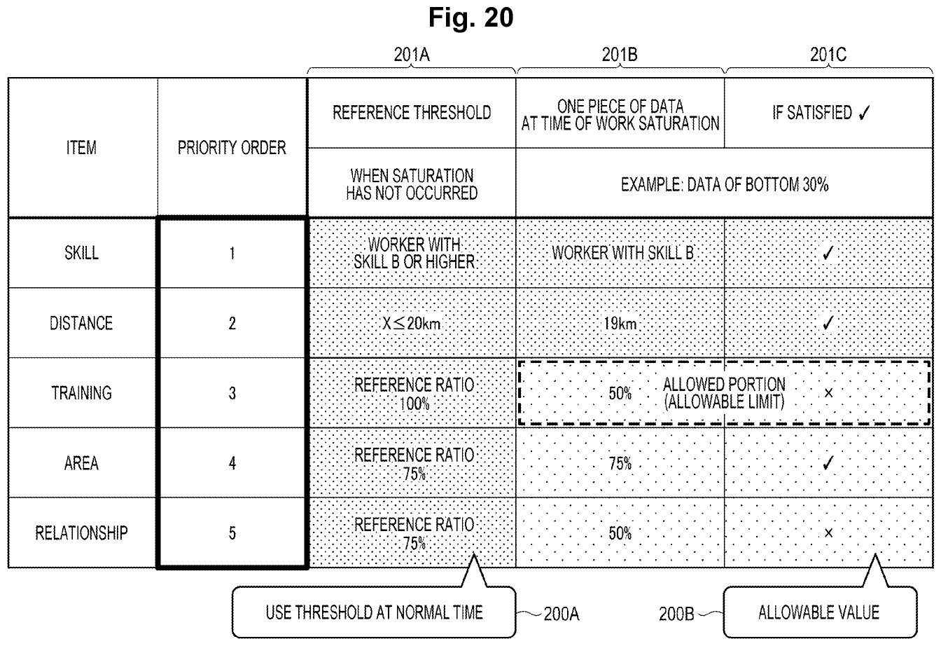

FIG. 20 illustrates an image of processing of determining the allowable limit for a certain piece of the data at time of saturation in relation to steps S51 to S53. A column 201A indicates an example of the reference threshold, a column 201B indicates an example of one piece of data (data of the bottom 30%) at the time of work saturation, and a column 201C represents whether or not each item of the column 201B satisfies the reference threshold. In this example, the item with the highest priority order is the item of “skill”, and the item with the lowest priority order is the item of “relationship”. First, for the data, the allowable value setting unit 17 compares information on the item “skill” having the highest priority order with the reference threshold. Since the value of the data is “worker with the skill B” while the reference threshold is “worker with the skill B or higher”, the reference threshold is satisfied (check mark). Next, the allowable value setting unit 17 compares information on the item “distance” having the second highest priority order with the reference threshold. Since the value of the data is “19 km” while the reference threshold is “X≤20 km”, the reference threshold is satisfied (check mark). Subsequently, the allowable value setting unit 17 compares information on the item “training” having the third highest priority order with the reference threshold. Since the value of the data is “50%” and the reference threshold is “100%”, the reference threshold is not satisfied (X mark). Thus, for this data, the value of the allowable limit is determined to be the value “50%” for “training”, and the value “50%” is stored in the allowable value setting data storage unit 25 together with the item information “training”. Such processing is repeated by the number of pieces of assignment table data. Note that, in the data of FIG. 20, a threshold at normal time is applied to a dark hatched portion (200A). A thinly hatched portion (200B) indicates an allowable value possibility (which cannot be said to be highly reliable at the present time) in the process of setting the allowable value.

In step S54, the allowable value setting unit 17 reads the value of the allowable limit from the allowable value setting data storage unit 25, and sets a value having the largest deviation among the read values as the allowable value.

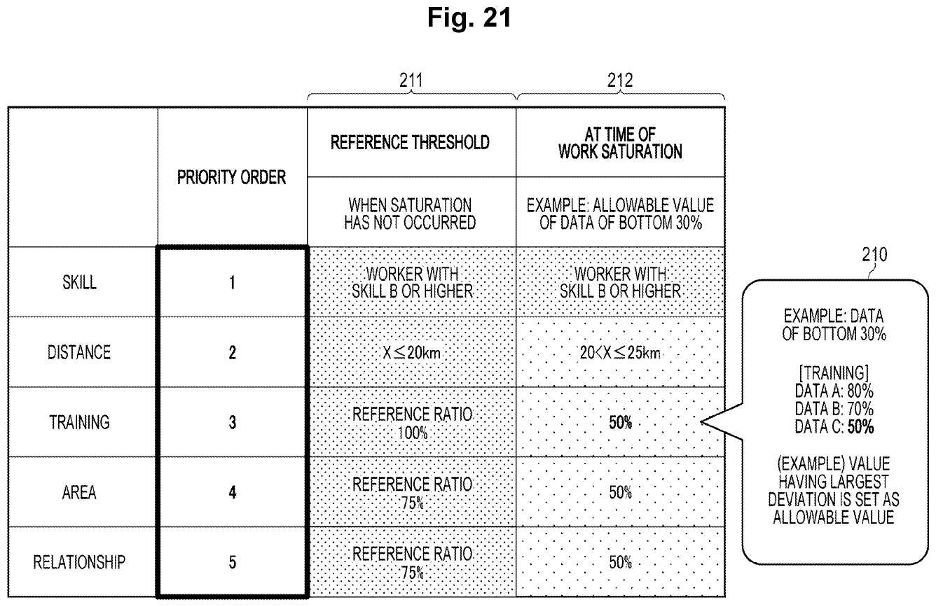

FIG. 21 illustrates an image of processing of setting a value having the largest deviation from the value recorded for the “data of the bottom 30%” of the data at time of work saturation as the allowable value in relation to step S54. A column 211 indicates an example of the reference threshold, and a column 212 indicates an example of the allowable value set for the data of the bottom 30%. For example, for the item “training”, in a case where the allowable limits of the analyzed three pieces of data are 80% for data A, 70% for data B, and 50% for data C, a value “50%” having the largest deviation from the reference threshold “100%” is set as the allowable value (210). The allowable value setting unit 17 performs similar processing for other items. In this example, allowable limits are observed for the items “distance”, “training”, “area”, and “relationship”, and “20<X≤25 km”, “50%”, “50%”, and “50%” are set as the allowable values, respectively.

Note that use of a value having the largest deviation as the allowable value is merely an example, and for example, in a case where the number of pieces of data is large, a standard value (average value) of the value of the allowable limit may be calculated and used as the allowable value.

By repeating the above processing by the number of pieces of assignment table data for each divided degree of saturation, it is possible to set an allowable value depending on the degree of saturation at the time of work saturation.

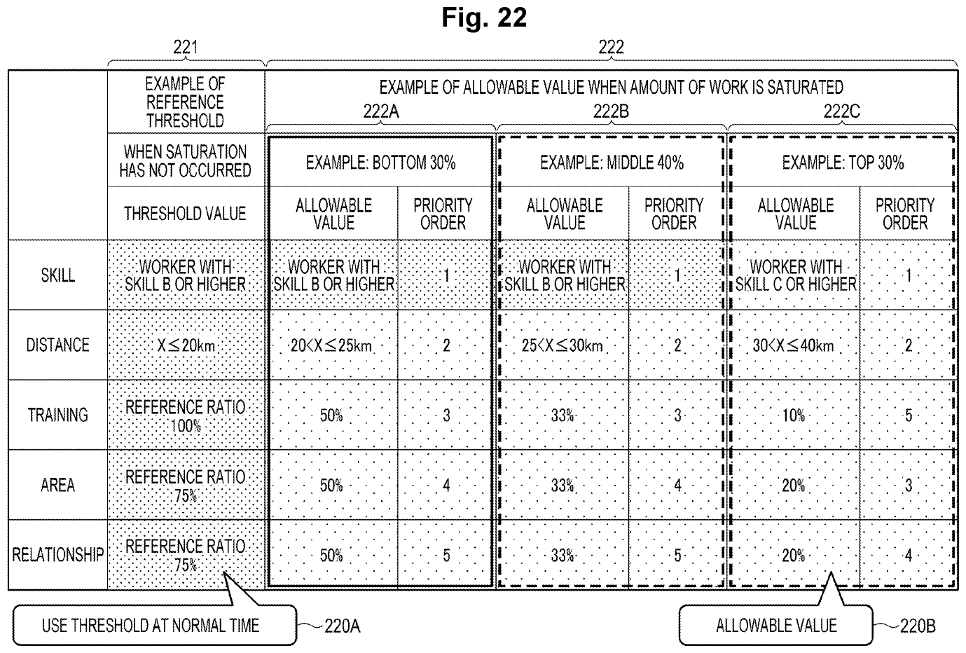

FIG. 22 illustrates an example of an allowable value obtained by the above processing. A threshold at normal time is applied to a dark hatched portion (220A), and an allowable value is applied to a thinly hatched portion (220B). A column 221 indicates an example of the reference threshold (a threshold when saturation has not occurred) obtained from the data at normal time. A column 222 indicates an example of the allowable value when the amount of work is saturated, and among the values, a column 222A indicates allowable values set from data with the degree of saturation of the bottom 30%, a column 222B indicates allowable values set from data with the degree of saturation of the middle 40%, and a column 222C indicates allowable values set from data with the degree of saturation of the top 30%. For example, in the case of the bottom 30%, for the “skill” in the first priority order, the allowable value at normal time “worker with the skill B or higher” is used as it is, but for the “distance” in the second priority order, an allowable value “20<X≤25 km” different from the allowable value at normal time “X≤20 km” is set. Similarly, an allowable value “50%” is set for the “training” in the third priority order, an allowable value “50%” is set for the “area” in the fourth priority order, and an allowable value “50%” is set for the “relationship” in the fifth priority order. In the case of the middle 40% (column 222B) and the case of the top 30% (column 222C), different allowable values can be set.

As described above, when the work is saturated if the work assignment table created in advance is used as it is, it is possible to perform adjustment in consideration of the priority order and the allowable value by referring to, for example, any of the columns 222A, 222B, and 222C depending on the degree of work saturation. For example, in a case where an allowable value on a certain day is created, the degree of work saturation on the certain day is set as Y₁, and

Y₁=(the number of pieces of work on a certain day)/(the number of workers on a certain day)

is obtained, and determination can be made depending on which degree of work saturation range of the plans of the “bottom 30%”, “middle 40%”, and “top 30%” the Y₁ corresponds.

That is, flexible response depending on a situation is possible, such that almost no consideration of training is needed at the time of disaster.

(3-7) Output

Finally, in step S6 of FIG. 3, the work assignment support device 1 generates and outputs output data indicating the determined priority order and allowable value, by the result output unit 18. The output data is presented to the user, for example, on a display as the output device 106, or is transmitted to an external device via the communication interface 107. The assigner can appropriately create an assignment plan on the basis of the output priority order and allowable value.

(3-8) Application Operation Example

It is also conceivable to change the priority order and the allowable value set as described above in real time. For example, in an emergency such as a disaster, the priority order or threshold of each item changes from moment to moment. Thus, by recording the number of pieces of work per worker of the classified plan, the priority order and the allowable value can be changed in real time depending on the number of workers and the number of pieces of work.

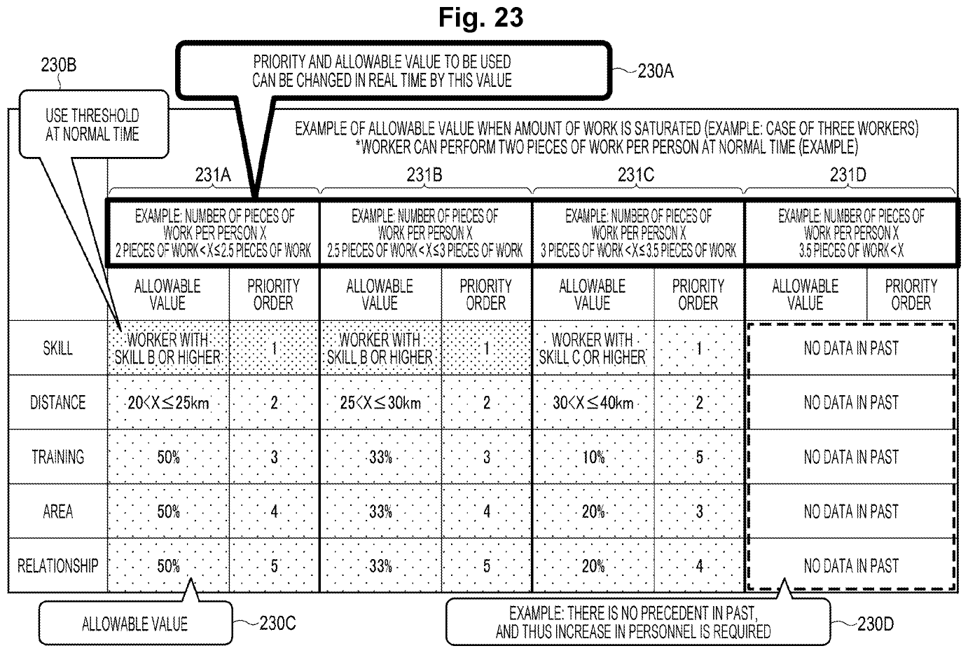

FIG. 23 illustrates an example in which the priority order and the allowable value when the amount of work is saturated can be changed in real time. In this example, it is assumed that there are three workers, and each worker can perform two pieces of work per person at normal time. The allowable value and the priority order are set on the basis of past data as described above. A column 231A includes information in a case where the number of pieces of work X per person is “2 pieces of work<X≤2.5 pieces of work”, a column 231B includes information in a case where the number of pieces of work X per person is “2.5 pieces of work<X≤3 pieces of work”, a column 231C includes information in a case where the number of pieces of work X per person is “3 pieces of work<X≤3.5 pieces of work”, and a column 231D includes information in a case where the number of pieces of work X per person is “3.5 pieces of work<X”. By calculating the degree of saturation of the real-time amount of work as the number of pieces of work per person, it is possible to determine which value in the columns 231A to 231D should be referred to. As a result, it is possible to change the priority order and the allowable value to be used in real time (230A). In FIG. 23, dark hatching means that a threshold at normal time is used (230B), and thin hatching means that an allowable value is used (230C).

Note that, in this example, in a case where the number of pieces of work X per person exceeds 3.5 pieces of work (column 231D), there has been no corresponding data of the degree of saturation in the past, and thus, the priority order and the allowable value are not set. If this is the case, there is no precedent, and thus an increase in personnel is required (230D).

### (4) Effects

As described above in detail, in the embodiment of the present invention, the work assignment support device 1 performs sorting into the assignment table data at normal time and the assignment table data at time of saturation by comparison between the workable amount and the actual amount of work on the basis of the past work assignment table data. Then, the work assignment support device 1 uses the assignment table data at normal time as a reference, and sets a reference threshold to each item. In addition, the work assignment support device uses the assignment table data at time of saturation to determine whether or not each item satisfies the reference threshold for each piece of the data, gives a higher priority order to an item with a smaller number of times of exceeding the reference threshold, and gives a lower priority order to an item with a larger number of times of exceeding the reference threshold. The work assignment support device 1 further records, for each of pieces of the data at time of saturation, a value of an item having the highest priority order among items not satisfying the reference threshold, and sets a value having the largest deviation from the reference threshold among the recorded values as an allowable value. The work assignment support device 1 can also determine the priority order and the allowable value depending on the degree of saturation by sectioning the data at time of saturation depending on the degree of work saturation.

The priority order is determined from the first to the N-th (N is the number of items). The reference threshold is determined as a maximum value or a minimum value for each item when the number of pieces of work or the amount of work is unsaturated (normal time). The allowable value is determined as a maximum value or a minimum value for each item when the number of pieces of work or the amount of work is saturated. By setting a bit in advance for the trainee and the work for training, it is possible to consider them as items as described above.

The work assignment support technology according to the embodiment roughly includes two points.

(Point 1) Even if requirement criteria are not satisfied, the priority order and the allowable value can be automatically created. In other words, even in a case where the requirement criteria cannot be satisfied, it is possible to automatically create the priority order depending on the item from the past assignment result. In addition, even in a case where an analysis method (mathematical optimization or the like) for priority setting is unknown, setting can be performed.

(Point 2) In addition, it is possible to automatically create the priority order and the allowable value depending on the situation at that time. In other words, the allowable value and the priority order depending on the degree of work saturation can be automatically created. As a result, allowable items and amounts at the time of work saturation depending on the situation are clarified, and degradation in safety and the like can be minimized.

That is, according to the work assignment support device, the work assignment support method, and the program according to the embodiment, it is possible to automatically set the allowable value depending on the priority order and the situation of the item at the time of work saturation without using a technology such as mathematical optimization. The assigner (including the tool) can create an assignment plan while considering safety and the like by using the priority order and the allowable value determined in this way. Even an assigner with less experience can create a high-quality assignment table on the basis of clear criteria, and can achieve homogenization and high quality of assignment work. In addition, since the automatically determined priority order and allowable value reflect past data, it is also possible to inherit assignment based on intuition or experience of an experienced assigner, as a technology. Furthermore, in the future, evaluation using an allowable value, establishment of an alert method for an assigner, and the like may be possible.

### Other Embodiments

Note that the present invention is not limited to the above-described embodiment. For example, the processing units 11 to 18 included in the work assignment support device 1 may be distributedly arranged in a plurality of devices, and the processing may be performed by these devices cooperating with each other. In addition, the processing units 11 to 18 may be implemented by using a circuit. The circuit may be a dedicated circuit that implements a specific function, or may be a general-purpose circuit such as a processor.

As an example, a case has been described in which the movement distance, the skill level of the worker, the worker training, the area that the worker is good at, and the human relationship with the construction company are considered as consideration target items in work assignment, but these are merely examples, and some items may be omitted, or other items may be added and replaced with other items. Items may be added, for example, a time zone suitable for work (morning/afternoon/nighttime), a day suitable for work (weekday/holiday, first half/second half of the week, first half/second half of the month, a day related to an effort by a company or a labor measure by a local government or a government (for example, “no overtime day” (a day on which it is recommended to leave work on time, such as every Wednesday), “premium Friday” (days on which reduced working hours are recommended, such as the fourth Friday), and the like), weather and climate suitable for work (clear/cloudy/rainy, temperature, humidity), age, sex, and residence of the worker, a desired work type of the worker (working at home, standing work/sitting work), equipment of the worker (necessity of masks, tools, and the like), qualification required for the worker, and the like.

Furthermore, the flow of the processing steps described above is not limited to the described procedure, and the order of some steps may be changed, or some steps may be performed simultaneously in parallel. In addition, the series of processing steps described above does not need to be executed temporally continuously, and each step may be executed at any timing. For example, only the reference threshold may be output after the reference threshold of each item is determined, or only the priority order may be output after the priority order of each item is determined.

The work assignment support device according to the embodiment can also be implemented by a computer and a program, and the program can be recorded in a recording medium or provided through a network. For example, the methods described in the above-described embodiments can be stored in a recording medium such as a magnetic disk (disk, hard disk, or the like), an optical disk (CD-ROM, DVD, or the like), or a semiconductor memory (ROM, RAM, flash memory, or the like) as programs (software) that can be executed by a computing machine (computer), or can also be distributed by being transmitted through a communication medium. Note that the programs stored on the medium side also include a setting program for configuring, in the computing machine, software (not only an execution program but also tables and data structures are included) to be executed by the computing machine. The computing machine that implements the present device executes the above-described processing by reading the programs recorded in the recording medium, constructing the software by the setting program as needed, and controlling the operation by the software. Note that the recording medium described in the present description is not limited to a recording medium for distribution, but includes a storage medium such as a magnetic disk or a semiconductor memory provided in the computing machine or in a device connected via a network.

In addition, also for the configuration and the like of each storage unit, various modifications can be made without departing from the gist of the present invention.

In short, the present invention is not limited to the above-described embodiments, and various modifications can be made in the implementation stage without departing from the gist thereof. In addition, the embodiments may be implemented in appropriate combination, and in this case, combined effects can be obtained. Furthermore, the above-described embodiments include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

1 Work assignment support device
11 Data acquisition unit
12 Reference-amount-of-work determination unit
13 Data classification unit
14 Reference threshold setting unit
15 Division unit
16 Priority order determination unit
17 Allowable value setting unit
18 Result output unit
21 Assignment table data storage unit
22 Data-at-normal-time storage unit
23 Data-at-time-of-saturation storage unit
24 Reference threshold storage unit
25 Setting data storage unit
101 CPU
102 RAM
103 ROM
104 Auxiliary storage device
105 Input device
106 Output device
107 Communication interface

1. A work assignment support device comprising:
a data classification unit, including one or more processors, configured to classify past assignment table data indicating assignment of work to workers into data at normal time and data at time of saturation by comparison between a workable amount determined from a number of the workers and an actual amount of work;
a threshold setting unit, including one or more processors, configured to set a threshold to each of a plurality of items on a basis of information on the plurality of items relating to an attribute of a worker, an attribute of work, or an attribute of a combination of a worker and work related to the data at normal time; and
a priority order determination unit, including one or more processors, configured to make determination whether or not information on each of the plurality of items related to the data at time of saturation satisfies the threshold, and determine priority order of the plurality of items on a basis of a result of the determination.

2. The work assignment support device according to claim 1, further comprising
an allowable value setting unit, including one or more processors, configured to specify information on an item of which the priority order is highest among items that do not satisfy the threshold for each of pieces of the data at time of saturation, and set an allowable value for each of the plurality of items on a basis of the information specified.

3. The work assignment support device according to claim 2, wherein
the allowable value setting unit is configured to specify the information on the item of which the priority order is the highest among the items that do not satisfy the threshold for each of pieces of the data at time of saturation, and set the allowable value for each of the plurality of items related to the data at time of saturation on a basis of information having a largest deviation from the threshold among the information specified.

4. The work assignment support device according to claim 2, further comprising
a division unit, including one or more processors, configured to divide the data at time of saturation into a plurality of sections depending on a degree of excess of the actual amount of work with respect to the workable amount, wherein
the priority order determination unit is configured to determine the priority order on a basis of the data at time of saturation, for each of the plurality of sections, and
the allowable value setting unit is configured to set the allowable value on the basis of the data at time of saturation, for each of the plurality of sections.

5. The work assignment support device according to claim 1, wherein
the priority order determination unit is configured to calculate a number of pieces of data in which the information does not satisfy the threshold for each of the plurality of items related to the data at time of saturation, and determine the priority order of the plurality of items such that an item having a larger number of pieces of data not satisfying the threshold has a lower priority order.

6. The work assignment support device according to claim 1, wherein the threshold setting unit is configured to set the threshold for each of the plurality of items by using a maximum value or a minimum value of each of the plurality of items in the data at normal time in a case where the information on the plurality of items is quantified.

7. A work assignment support method comprising:
classifying past assignment table data indicating assignment of work to workers into data at normal time and data at time of saturation by comparison between a workable amount determined from a number of the workers and an actual amount of work;
setting a threshold to each of a plurality of items on a basis of information on the plurality of items relating to an attribute of a worker, an attribute of work, or an attribute of a combination of a worker and work related to the data at normal time; and
making determination whether or not information on each of the plurality of items related to the data at time of saturation satisfies the threshold, and determining priority order of the plurality of items on a basis of a result of the determination.

8. A non-transitory computer-readable storage medium storing a program for causing a computer to perform operations comprising:
classifying past assignment table data indicating assignment of work to workers into data at normal time and data at time of saturation by comparison between a workable amount determined from a number of the workers and an actual amount of work;
setting a threshold to each of a plurality of items on a basis of information on the plurality of items relating to an attribute of a worker, an attribute of work, or an attribute of a combination of a worker and work related to the data at normal time; and
making determination whether or not information on each of the plurality of items related to the data at time of saturation satisfies the threshold, and determines priority order of the plurality of items on a basis of a result of the determination.

9. The work assignment support method of claim 7, further comprising:
specifying information on an item of which the priority order is highest among items that do not satisfy the threshold for each of pieces of the data at time of saturation, and setting an allowable value for each of the plurality of items on a basis of the information specified.

10. The work assignment support method of claim 9, wherein setting the allowable value for each of the plurality of items comprises:
setting the allowable value for each of the plurality of items related to the data at time of saturation on a basis of information having a largest deviation from the threshold among the information specified.

11. The work assignment support method of claim 9, further comprising:
dividing the data at time of saturation into a plurality of sections depending on a degree of excess of the actual amount of work with respect to the workable amount;
determining the priority order on a basis of the data at time of saturation, for each of the plurality of sections; and
setting the allowable value on the basis of the data at time of saturation, for each of the plurality of sections.

12. The work assignment support method of claim 7, wherein determining the priority order of the plurality of items comprises:
calculating a number of pieces of data in which the information does not satisfy the threshold for each of the plurality of items related to the data at time of saturation; and
determining the priority order of the plurality of items such that an item having a larger number of pieces of data not satisfying the threshold has a lower priority order.

13. The work assignment support method of claim 7, wherein setting the threshold for each of the plurality of items comprises:
setting the threshold for each of the plurality of items by using a maximum value or a minimum value of each of the plurality of items in the data at normal time in a case where the information on the plurality of items is quantified.

14. The non-transitory computer-readable storage medium of claim 8, wherein the operations further comprise:
specifying information on an item of which the priority order is highest among items that do not satisfy the threshold for each of pieces of the data at time of saturation, and setting an allowable value for each of the plurality of items on a basis of the information specified.

15. The non-transitory computer-readable storage medium of claim 14, wherein setting the allowable value for each of the plurality of items comprises:
setting the allowable value for each of the plurality of items related to the data at time of saturation on a basis of information having a largest deviation from the threshold among the information specified.

16. The non-transitory computer-readable storage medium of claim 14, wherein the operations further comprise:
dividing the data at time of saturation into a plurality of sections depending on a degree of excess of the actual amount of work with respect to the workable amount;
determining the priority order on a basis of the data at time of saturation, for each of the plurality of sections; and
setting the allowable value on the basis of the data at time of saturation, for each of the plurality of sections.

17. The non-transitory computer-readable storage medium of claim 8, wherein determining the priority order of the plurality of items comprises:
calculating a number of pieces of data in which the information does not satisfy the threshold for each of the plurality of items related to the data at time of saturation; and
determining the priority order of the plurality of items such that an item having a larger number of pieces of data not satisfying the threshold has a lower priority order.

18. The non-transitory computer-readable storage medium of claim 8, wherein setting the threshold for each of the plurality of items comprises:
setting the threshold for each of the plurality of items by using a maximum value or a minimum value of each of the plurality of items in the data at normal time in a case where the information on the plurality of items is quantified.
